(19) United States
(12) Patent Application Publication
(10) Pub. No.: US 2022/0227020 A1
(43) Pub. Date: Jul. 21, 2022

(54) METHOD FOR MANUFACTURING COMPOSITE WOOD FLOOR

(71) Applicant: JUU YUAN WOODEN MANUFACTURING CO., LTD., TAICHUNG CITY (TW)

(72) Inventor: CHENG YEN CHEN, TAICHUNG CITY (TW)

(21) Appl. No.: 17/152,030

(22) Filed: Jan. 19, 2021

(51) Int. Cl. B27M 3/06; E04F 15/04; E04F 15/02

(52) U.S. Cl. CPC B27M 3/06; B32B 21/14; E04F 15/02038; E04F 15/045

(57) ABSTRACT

A method for manufacturing composite wood floor includes a step of obtaining top layers, a step of coloring, a step of applying adherent, a step of forming composite unit, a step of machining, and a step of applying protection layer. The tissues of the top layers infiltrated with colors, and the colored top layers are combined with at least one base material to form a composite solid wood floor. The solid wood floor is easily maintained to remove scratches.

### BACKGROUND OF THE INVENTION

### 1. Fields of the Invention

The present invention relates to a floor, and more particularly, to a method for manufacturing composite wood floor, and the floor is easily to remove scratches.

### 2. Descriptions of Related Art

The conventional ways to color wood floor includes method of spraying, painting, roasting or chemical treatment. However, the color is coated on the surface of the floor so that it is easily removed when the floor is scratched. The color removed area is obvious and different from the rest portion of the floor, and this makes the floor look old.

Once there is a scratched area on the wood floor, it is difficult for the users to recover the color to the scratched areas.

The composite wood floor is made generally to combine barks or wood boards with base material. The combination is then made with T&G or clicks. Multiple layers of paints are then applied, and a protection paint finally painted on the outer layer of the composite wood floor.

The maintenance to the composite wood floor is to grind the surface and then paint. This way can ensure that there is no individual scratched area left. However, to grind the surface of the large area floor can be costly.

The present invention intends to provide a method for manufacturing composite wood floor, and the composite wood floor is easily maintained and the color is not removed.

### SUMMARY OF THE INVENTION

The present invention relates to a method for manufacturing composite wood floor, and the method comprises the following steps:

a step “a” of obtaining top layers: removing barks from tree logs and trimming the logs into cylindrical sections, rotationally cutting the logs into multiple top layers;

a step “b” of coloring: infiltrating colors into tissues of the top layers by way of soaking-and-boiling in water or high-pressure boiling in water, and the top layers then being dried;

a step “c” of applying adherent: applying a layer of adherent to the top layers, drying the top layers and reducing humidity from the top layers to keep the top layers at 8% to 10% of humidity;

a step “d” of forming composite unit: combining the top layer with a base material under pressure and temperature to form a composite unit;

a step “e” of machining: machining the composite unit and polishing the composite unit, and

a step “f” of applying protection layer: applying a protection layer to a top surface of the composite unit.

The present invention also provides a composite wood floor and comprises a base layer which is a solid wood board. A top layer is colored by infiltrating colors into tissues of the top layers. An adherent layer is located between the base layer and the top layer to combine the base layer and the top layer to be a composite unit. The composite unit is shaped and polished. A protection layer is applied to the top surface of the composite unit. The protection layer is a transparent paint or a wood paint.

Preferably, the base layer includes a tenon and a mortise respectively formed in two sides thereof.

Preferably, the tenon and the mortise are made of different materials.

The advantages of the present invention are that the colors are infiltrated into the tissues of the top layers, and the colors are not affected by light and sunshine so that the colors can keep for a long period of time.

When the floor has a scratch, because the colors infiltrated into the tissues of the top layers so that the scratched area has the identical color as the rest portions of the floor. A layer of transparent paint applied to the scratched area can make the scratched area be ignored. Therefore, the maintenance mentioned above is only applied to the scratched area, the rest portion of floor does not need to be ground.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates the steps of the method of the present invention;

FIG. 2 is a cross sectional view to show the composite wood floor of the present invention, and

FIG. 3 is a cross sectional view to show that the composite wood floor of the present invention includes a tenon and a mortise respectively formed in two sides thereof.

### DETAILED DESCRIPTION OF THE PREFERRED EMBODIMENT

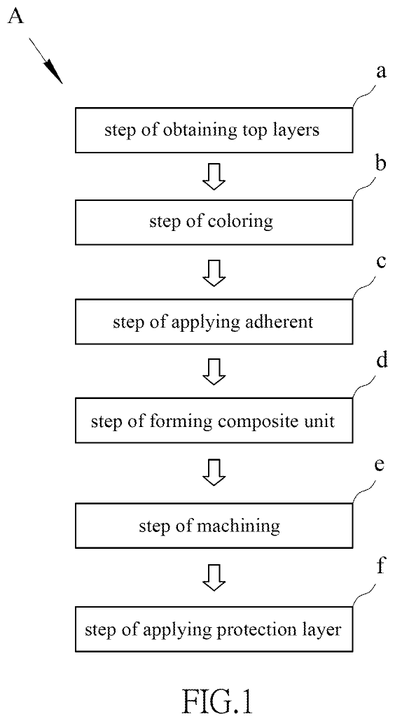

Referring to FIG. 1, the method “A” for manufacturing a composite wood floor comprises the following steps:

a step “a” of obtaining top layers: removing barks from tree logs and trimming the logs into cylindrical sections, rotationally cutting the logs into multiple top layers;

a step “b” of coloring: infiltrating colors into tissues of the top layers by way of soaking-and-boiling in water or high-pressure boiling in water, and the top layers then being dried;

a step “c” of applying adherent: applying a layer of adherent to the top layers, drying the top layers and reducing humidity from the top layers to keep the top layers at 8% to 10% of humidity;

a step “d” of forming composite unit: combining the top layer with a base material under pressure and temperature to form a composite unit;

a step “e” of machining: machining the composite unit and polishing the composite unit, and

a step “f” of applying protection layer: applying a protection layer to a top surface of the composite unit.

The present invention also relates to a composite wood floor “B” that is made by the method “A” of the present invention. The composite wood floor “B” comprises a base layer 2, a top layer 3, an adherent layer 4, and a protection layer 5. The base layer 2 is a solid wood board and the top layer 3 is colored by infiltrating colors into tissues of the top layers 3. The adherent layer 4 is located between the base layer 2 and the top layer 3 to combine the base layer 2 and the top layer 3 as a composite unit 1. The protection layer 5 is applied to the top surface 11 of the composite unit 1. The protection layer 5 can be a transparent paint or a wood paint.

In the step “b” of coloring, for the “soaking-and-boiling in water”, for instance, the top layers are soaked in a color agent for 24 to 72 hours, and then heated under 70 to 80 degrees Celsius for 6 to 7 hours. The water of the “soaking-and-boiling in water” may be added with alcohol or ammonia. For the “high-pressure boiling in water”, for instance, the top layers in the step “b” of coloring are soaked in a color agent and then heated in water under 70 to 80 degrees Celsius and under pressure of 10 to 90 kgf/cm² for 1 to 5 hours. The top layers in the step “b” of coloring are dried to have moisture content of 6% to 8% by a high-temperature machine under high pressure.

In the step “c” of applying adherent, the adherent is applied by way of vacuum gluing 6. The top layers are put in a sealed box, and a vacuum machine is used to vacuum the inside of the sealed box. Resin (adherent) is then introduced into the sealed box and applied to the surface of the top layers. Air is then introduced into the sealed box until a 10 kg of pressure is formed in the sealed box to allow the top layers to absorb the adherent. The top layers with the adherent have 8% to 10% of humidity.

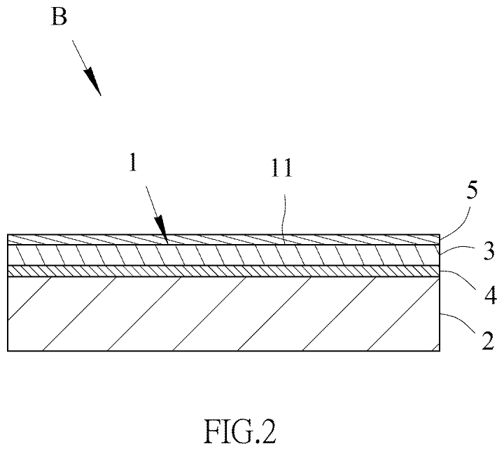

In the step “d” of forming composite unit, the top layer and a base material are combined under pressure and temperature to form a composite unit. The top layers are arranged by the colors according to a specific arrangement or layout idea. The top layers sent into a machine which has a top press board and a bottom press board, and the top layers are heated to 190 degrees Celsius under 0.5 tons of pressure for 30 minutes. The composite unit is then cooled. As shown in FIG. 2, the top layers form the top layer 3 of the composite unit 1. The base material forms the base layer 2, and the adherent forms the adherent layer 4 of the composite unit 1.

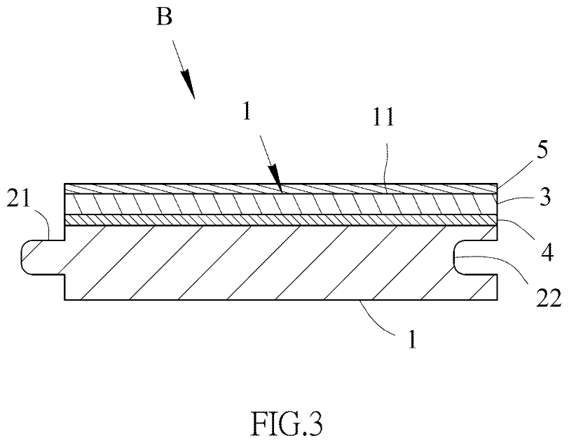

In the step “e” of machining, the composite unit is polished, cut and trimmed to be desired shape. As shown in FIG. 3, the base layer 2 includes a tenon 21 and a mortise 22 respectively formed in two sides thereof.

In the step “f” of applying protection layer, a protection layer is applied to the top surface of the composite unit to form the protection layer 4.

As shown in FIG. 3, the base layer 2 includes a tenon 21 and a mortise 22 respectively formed in two sides thereof, wherein the tenon 21 and the mortise 22 are made of the same material or different materials.

While we have shown and described the embodiment in accordance with the present invention, it should be clear to those skilled in the art that further embodiments may be made without departing from the scope of the present invention.

What is claimed is:

1. A method for manufacturing composite wood floor, comprising:
a step of obtaining top layers: removing barks from tree logs and trimming the logs into cylindrical sections, rotationally cutting the logs into multiple top layers;
a step of coloring: infiltrating colors into tissues of the top layers by way of soaking-and-boiling in water or high-pressure boiling in water, and the top layers then being dried;
a step of applying adherent: applying a layer of adherent to the top layers, drying the top layers and reducing humidity from the top layers to keep the top layers at 8% to 10% of humidity;
a step of forming composite unit: combining the top layer with a base material under pressure and temperature to form a composite unit;
a step of machining: machining the composite unit and polishing the composite unit, and
a step of applying protection layer: applying a protection layer to a top surface of the composite unit.

2. The method as claimed in claim 1, wherein the top layers in the step of coloring are soaked in a color agent for 24 to 72 hours and then heated under 70 to 80 degrees Celsius for 6 to 7 hours.

3. The method as claimed in claim 2, wherein the soaking-and-boiling in water in the step of coloring adds alcohol or ammonia in the water.

4. The method as claimed in claim 1, wherein the top layers in the step of coloring are soaked in a color agent and then heated in water under 70 to 80 degrees Celsius and under pressure of 10 to 90 kgf/cm² for 1 to 5 hours.

5. The method as claimed in claim 1, wherein the adherent is applied by way of vacuum gluing in the step of applying adherent.

6. The method as claimed in claim 1, wherein the top layers in the step of forming composite unit are heated to 190 degrees Celsius under 0.5 tons of pressure for 30 minutes.

7. The method as claimed in claim 1, wherein the top layers in the step of coloring are dried to have moisture content of 6% to 8% by a high-temperature machine under high pressure.

8. A composite wood floor comprising:
a base layer being a solid wood board;
a top layer being colored by infiltrating colors into tissues of the top layers;
an adherent layer located between the base layer and the top layer to combine the base layer and the top layer as a composite unit, the composite unit being shaped and polished, and
a protection layer being applied to a top surface of the composite unit, the protection layer being a transparent paint or a wood paint.

9. The composite wood floor as claimed in claim 8, wherein the base layer includes a tenon and a mortise respectively formed in two sides thereof.

10. The composite wood floor as claimed in claim 8, wherein the base layer includes a tenon and a mortise respectively formed in two sides thereof, the tenon and the mortise are made of different materials.
